(19) United States
(12) Patent Application Publication
(10) Pub. No.: US 2006/0194181 A1
(43) Pub. Date: Aug. 31, 2006

(54) Method and apparatus for electronic books with enhanced educational features

(75) Inventor: Louis Barry Rosenberg, Pismo Beach, CA (US)

Correspondence Address: SINSHEIMER JUHNKE LEBENS & MCIVOR, LLP, 1010 PEACH STREET, P.O. BOX 31, SAN LUIS OBISPO, CA, 93406, US

(73) Assignee: Outland Research, LLC, Pismo Beach, CA (US)

(21) Appl. No.: 11/271,172

(22) Filed: Nov. 10, 2005

Related U.S. Application Data
(60) Provisional application No. 60/657,608, filed on Feb. 28, 2005.

(51) Int. Cl. G09B 5/00

(52) U.S. Cl. 434/317; 434/307 R

(57) ABSTRACT

A method of visually correlating text and speech includes receiving a source file; generating, based on the source file, a page display image including a series of text segments, the generating including rendering the series of text segments with a first set of display characteristics; receiving an input signal representing an utterance; processing the received input signal to determine whether at least a portion of a text segment included within the generated page display image has been uttered; identifying the text segment determined to have been at least partially uttered; rendering the identified text segment with a second set of display characteristics; and enabling the generated page display image to be visually represented on an output device, wherein the identified text segment is rendered with the second set of display characteristics substantially simultaneously upon receiving the input signal.

This application claims the benefit of U.S. Provisional Application No. 60/657,608, filed Feb. 28, 2005, of Louis Barry Rosenberg, for METHOD AND APPARATUS FOR ELECTRONIC BOOKS WITH ENHANCED EDUCATIONAL FEATURES which is incorporated in its entirety herein by reference.

### BACKGROUND OF THE INVENTION

1. Field of the Invention

The present invention relates generally to portable electronic books (i.e., eBooks), and particularly to methods and apparatus for enabling educational eBook systems for children that allow a shared child-parent educational experience. More specifically, the present invention relates to methods and apparatus that allow parents, mentors, and/or other skilled readers to verbally recite a story to a child, children, and/or other unskilled readers by reading from an eBook and while having that eBook provide a technologically enhanced educational experience for the child, children, and/or other unskilled reader.

2. Discussion of the Related Art

It has been shown by educational research that children have an easier time learning to read if their parents read to them often when they are small children. The premise is that children learn to better recognize letters, words, and sentence structures as a result of hearing their parents read aloud to them from simple children's books while they themselves look at the pictures and text on the page. It is recommended by educators that parents use a finger point at the words as they read those words to children, helping to make the connection between each spoken word and the text representation of that word. This is often difficult to achieve however, for it is awkward to point at words while reading, especially when the text is small and/or if the page is filled with pictures. As a result, it is often unclear what word the parent is pointing to, the word itself is obscured by the parent's finger, and/or the child is bothered by the parent's hand blocking other things on the page such as the pictures. Also the parent's finger is usually too large to point at specific syllables of individual words as they are spoken. For these reasons there is a need for an improved way to coordinate a parent's spoken words while reading a book to a child with a visual indication of which written word is being recited.

Many proposed solutions involve automated reading systems (e.g., automated DVD books) that use computer technology to automatically read aloud while highlighting text displayed to a child viewer. This creates a connection between spoken words and written text, but it takes the parent completely out of the process. According to educational research however, having a parent involved with the child inspires a life long love of reading and is a more effective pedagogical process. Furthermore it is recommended by educators that parents do more than simply read a book to children, but ask questions along the way, turning the story reading process into an interactive discussion. What is needed, therefore, is an improved way for children and parents to interact with books, allowing parents to control the book reading process while also providing an improved way to correlate the spoken representation of the story with the written text of the story.

### SUMMARY OF THE INVENTION

Several embodiments of the invention advantageously address the needs above as well as other needs by providing methods and systems for electronic books with enhanced educational features.

In one embodiment, the invention can be characterized as a method of visually correlating text and speech that includes receiving a source file; generating, based on the source file, a page display image including a series of text segments, the generating including rendering the series of text segments with a first set of display characteristics; receiving an input signal representing an utterance; processing the received input signal to determine whether at least a portion of a text segment included within the generated page display image has been uttered; identifying the text segment determined to have been at least partially uttered; rendering the identified text segment with a second set of display characteristics; and enabling the generated page display image to be visually represented on an output device, wherein the identified text segment is rendered with the second set of display characteristics substantially simultaneously upon receiving the input signal.

In another embodiment, the invention can be characterized as a system for visually correlating text and speech that includes a storage medium adapted to store a source file; a text rendering engine adapted to generate a page display image based on the source file, the page display image including a series of text segments rendered with a first set of display characteristics; an input port adapted to receive an input signal representing an utterance; speech recognition circuitry adapted to process the received input signal, determine whether at least a portion of a text segment included within the generated page display image has been uttered, and to output data to the text rendering engine, the output data identifying the text segment determined to have been at least partially uttered; and an output port adapted to transmit the generated page display image to an output device, wherein the text rendering engine is further adapted to render text segments identified by the speech recognition circuitry with a second set of display characteristics substantially simultaneously upon receiving the input signal.

### BRIEF DESCRIPTION OF THE DRAWINGS

The above and other aspects, features and advantages of several embodiments of the present invention will be more apparent from the following more particular description thereof, presented in conjunction with the following drawings.

FIG. 1 illustrates a diagram illustrating a system in which one embodiment of the present invention can be practiced.

FIG. 2 illustrates an electronic book in accordance with one embodiment of the present invention.

FIG. 3 is a block diagram illustrating generally components or modules that are used to support the rendering of document pages in accordance with the current invention.

FIG. 4 illustrates one embodiment of an eBook binary file for storing an eBook in accordance with the current invention.

FIG. 5 illustrates a page including text and graphics from a children's book when displayed in digital form by an electronic book in accordance with one embodiment of the present invention, wherein the displayed text is rendered with a normal set of display characteristics.

FIG. 6 illustrates the page shown in FIG. 5, wherein a first portion of the displayed text is rendered with an accentuated set of display characteristics substantially simultaneously with a reading user's vocalization of the first portion of the displayed text, in accordance with one embodiment of the present invention.

FIG. 7 illustrates the page shown in FIG. 5, wherein a second portion of the displayed text is rendered with an accentuated set of display characteristics substantially simultaneously with a reading user's vocalization of the second portion of the displayed text and the first portion of the displayed text is re-rendered with a normal set of display characteristics, in accordance with one embodiment of the present invention.

Corresponding reference characters indicate corresponding components throughout the several views of the drawings. Skilled artisans will appreciate that elements in the figures are illustrated for simplicity and clarity and have not necessarily been drawn to scale. For example, the dimensions of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention.

### DETAILED DESCRIPTION

The following description is not to be taken in a limiting sense, but is made merely for the purpose of describing the general principles of exemplary embodiments. The scope of the invention should be determined with reference to the claims.

Advances in computer and communication technology have provided a convenient and economical way to access information in a variety of media. One particular area of information access includes electronic books. As disclosed in U.S. Pat. No. 6,493,734, which is hereby incorporated by reference for all purposes as if fully set forth herein, an electronic book is a device that receives and displays documents, publications, or other reading materials downloaded from an information network. An electronic book can also be a device that receives and displays documents, publication, and/or other reading materials accessed from a data storage device such as a CD, flash memory, or other permanent and/or temporary memory storage medium. In several embodiments of the present invention, users of an electronic book can read downloaded contents of documents, publications, or reading materials subscribed from a participating bookstore at their own convenience without the need to purchase printed version. When reading the documents, publications, or reading materials, users of an electronic book can advance pages forward or backward, jump to any particular page, navigate a table of contents, and/or scale the pages of the reading materials up or down depending on the users' preferences.

Many embodiments of the present invention disclosed herein provide a system and method allowing both children and parents to interact with books while allowing parents to control the book reading process in addition to providing an improved way to correlate the spoken representation of the story with the written text of the story. In one embodiment, computer controlled eBook technologies, capable of displaying digitized representation of books upon a screen, can be used. Using such an eBook, a user (e.g., a parent) can read a plurality of books to children, wherein the books can be displayed on a screen for both the parent and child to view together. In another embodiment, speech recognition circuitry is incorporated into the computer controlled eBook to detect and process the voice of the parent as he or she reads to the child. By processing the voice of the parent as the book is being read, the eBook can be configured with specialized text-accentuating software routines to accentuate a particular word being spoken by the parent at any given time. In this way the parent and child can view the book together, the parent can read the book at his or her own rate, digressing with questions and discussions at will, all while software running within the eBook tracks the parent's verbal progress as he or she reads the story and accentuates the individual text word upon the display screen that is being spoken by the parent at any given time. In some embodiments the text-accentuating software routines accentuate the entire word that the parent has just spoken, or has just begun to speak. In some embodiments the text-accentuating software routines accentuate a part of the word, such as the syllable, that has just been spoken or has just begun to speak. In some embodiments the text-accentuating software routines are “predictive” in that they accentuate a word and/or syllable of a word just before the parent speaks it. In many embodiments, words/syllables are accentuated by the text-accentuating software substantially simultaneously with the actual speaking of the particular words/syllables.

In the following description, the terms “electronic publications”, “electronic documents”, and “electronic text” are used interchangeably and generally to refer to reading materials that can be read by individuals or users, the materials including displayable text and, optionally, displayable illustrations, photographs, animations, video clips, and/or other visual content.

The terms “remote viewing system”, “portable viewer”, “electronic book”, and “display device” interchangeably refer to systems adapted to allow users to view reading materials. Such systems include dedicated eBook devices as well as multi-function devices that perform eBook functions in addition to other functions. Examples of multi-function devices include but are not limited to laptop computers, portable media players, pen computers, and/or personal digital assistants that are specifically configured to support eBook functionality in addition to other general computing functionalities.

The terms “user interface”, “navigation”, “control”, and “manipulation” interchangeably refer to methods for controlling the environment of the reading materials. The term “page displaying image” refers to an arrangement of pixels on a display screen or an output device to create a visual representation of a page of reading material, including text and optionally other visual content such as illustrations. The terms “rendering” and “imaging” interchangeably refer to the act of arranging pixels of on an output device to create a page display image.

The term “speech recognition” generally refers to methods of capturing the voice of a user through a sound input device such as a microphone, representing the user's voice as data, and processing that data to determine what phoneme, syllable(s), or word(s) the user is currently speaking or has spoken. Speech recognition methods often include calibration methods wherein a user speaks sounds and/or words, a representation of the user's voice speaking the sounds and/or words being captured and stored as data by computer hardware and software for use later in identifying what phoneme, syllable, syllables, word, or word, the user is then speaking.

As disclosed by PC Word magazine article How it Works: Speech Recognition on Apr. 14, 2000, and hereby incorporated by reference for all purposes as if fully set forth herein, speech recognition works by capturing a user's voice and turning it into a form that the computer can understand. A microphone converts a user's voice into an analog signal and feeds it to the PC's sound card or other means for converting the voice signal into digital data. An analog-to-digital converter converts the voice signal into a stream of digital data (ones and zeros). Then the software routines go to work. While each of the leading speech recognition companies has its own proprietary methods, the two primary components of speech recognition are common across products.

The first major component, called the acoustic model, analyzes the sounds of the user's voice and converts them to phonemes—the basic elements of speech. The English language contains approximately 50 phonemes. To analyze the sounds of a user's voice, the acoustic model first removes noise and unneeded information such as changes in volume. Next, using mathematical calculations, it reduces the data to a spectrum of frequencies (the pitches of the sounds), analyzes the data, and converts the words into digital representations of phonemes.

The second major component, called the language model, analyzes the content of the user's speech by comparing the combinations of phonemes to the words in its digital dictionary, a huge database of the most common words in the English language. Most of today's packages come with dictionaries containing about 150,000 words. The language model quickly decides which words the user spoke and responds accordingly.

Unfortunately, English synonyms (as well as words of other languages) complicate things. For example, in English the words “there,” “their,” and “they're” all sound the same. Using trigrams, however, speech recognition software can analyze the context in which a word is used to determine the actual word that has been spoken. In many cases, the software recognizes a word by looking at two words that come before it. If you say, for example, “Let's go there,” the phrase “let's go” helps the software decide to use “there” instead of “their.”

Speech recognition packages also tune themselves to the individual user. The software customizes itself based on the user's voice, their unique speech patterns, and their accent. To improve dictation accuracy, it creates a supplementary dictionary of the words you use. This is done through a calibration routine in which the user speaks a variety of words.

Today speech recognition software routines can achieve over 95% accuracy and are capable of identifying spoken words at a rate of over 160 words per minute. Speech recognition software routines often use artificial intelligence rules to determine what words the speaker is speaking. There currently exist commercially available speech recognition software engines such as Apple Speech Recognition, from Apple Computer and Microsoft .NET Speech Technologies and Via Voice from IBM Corporation. The methods and systems of the present invention can use the voice processing routines from such commercial products in part or in whole, or could employ custom developed voice processing routines specific to the current application.

Because a user of the electronic book disclosed herein recites text from a known story, the speech recognition requirements of the various disclosed embodiments are significantly less demanding than the general purpose speech recognition tasks employed by the products from Apple, Microsoft, and IBM as described above. Accordingly, the speech recognition circuitry employed in the disclosed embodiments need only identify when a word is spoken that matches the next expected word in the text story—a far simpler task than identifying a word from a full language dictionary of possible words. Because words recited from a story by a user have significant context and structure associated with them, speech recognition circuitry employed within embodiments of the present invention can be significantly faster, more accurate, and requires less processing power than general purpose speech recognition circuitry.

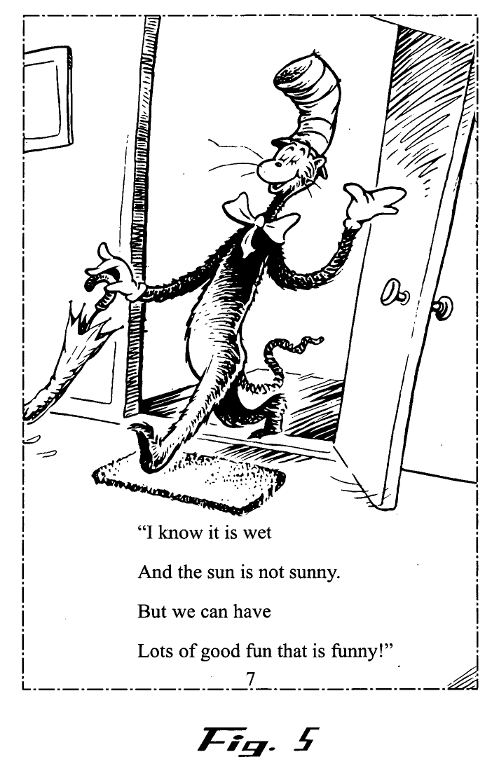

For example, if a user is reading a page in the story as shown in FIG. 5, speech recognition circuitry can easily identify the what word the user is going to recite next because it is already known what the next word in the story is. If the user has just recited the phrase “I know it is wet and the sun is not,” the speech recognition circuitry knows that the next word to be recited by the user should be “sunny”. Therefore if any word recited by the user sounds sufficiently similar to the word “sunny,” as determined based upon the phonemes identified from the voice input data, speech recognition circuitry concludes that the word recited was in fact “sunny” without needing to compare the identified phonemes with an entire dictionary of other possible words. If, on the other hand, the word recited by the user sounds sufficiently different than “sunny,” as determined based upon the phonemes identified from the voice input data, speech recognition circuitry concludes that the user is not reading the page from the story (e.g., the user is having a side conversation) without needing to compare the identified phonemes with an entire dictionary of words. In this way, the speech recognition circuitry need not search an entire language dictionary of words or use other time- and/or processing consuming methods (e.g., analyzing the user's sentence context to identify currently spoken words) because speech recognition circuitry knows what words to expect from the user based upon the order of words in the story. This knowledge this thus used to quicken and simplify speech recognition processes.

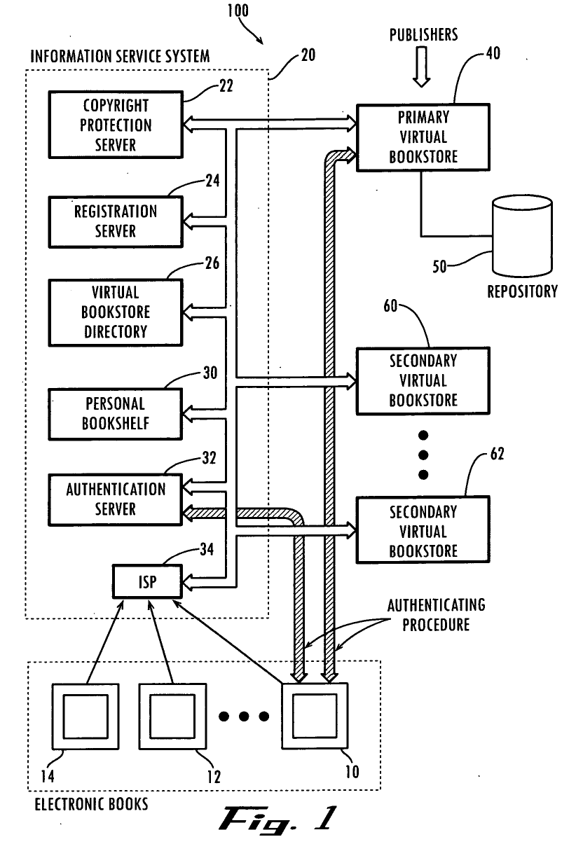

FIG. 1 illustrates a diagram illustrating a system 100 in which one embodiment of the present invention can be practiced.

Referring to FIG. 1, the system 100 can include at least one portable electronic book 10 operative to request an electronic document or publication from a catalog of distinct electronic reading materials, and to receive and display the requested electronic document or publication, an information services system 20 which includes an authentication server 32 for authenticating the identity of the requesting portable electronic book 10 and a copyright protection server 22 for rendering the requested electronic document or publication sent to the requesting portable electronic book 10 readable only by the requesting portable electronic book 10, at least one primary virtual bookstore 40 in electrical communication with the information services system 20, the primary virtual bookstore being a computer-based storefront accessible by the portable electronic book and including the catalog of distinct electronic reading materials, and a repository 50 in communication with the primary virtual bookstore 40, for storing the distinct electronic reading materials listed in the catalog.

The system may include more than one portable electronic book 10 as illustrated in FIG. 1 by including portable electronic books 12 and 14. The system also includes more than one virtual bookstore 40, each serving a different set of customers, each customer owning a portable electronic book. In one embodiment of the invention, the system 100 further comprises a secondary virtual bookstore 60 in communication with the information services system 20. In this case, the information services system also includes a directory of virtual bookstores 26 in order to provide the portable electronic book 10 with access to the secondary virtual bookstore 60 and its catalog of electronic reading materials.

In one embodiment, the information services system 20 comprises a centralized bookshelf 30 associated with each portable electronic book 10 in the system. Each centralized bookshelf 30 contains all electronic reading materials requested and owned by the associated portable electronic book 10. Each portable electronic book 10 user can permanently delete any of the owned electronic reading materials from the associated centralized bookshelf 30. Since the centralized bookshelf 30 contains all the electronic reading materials owned by the associated portable electronic book 10, these electronic reading materials may have originated from different virtual bookstores. The centralized bookshelf 30 is a storage extension for the portable electronic book 10. Such storage extension is needed in some embodiments since the portable electronic book 10 likely has limited non-volatile memory capacity.

The user of the portable electronic book 10 can add marks, such as bookmarks, inking, highlighting and underlining, and annotations on an electronic publication, document, or reading material displayed on the screen of the portable electronic book, then stores this marked reading material in the non-volatile memory of the electronic book 10. In one embodiment, the user can also add audible marks as audio information that is associated with particular words, lines, paragraphs, pages, illustrations, or any other visual content displayed as part of an electronic publication. The audio information can include digitized samples of the user's voice as captured by a microphone attached to and/or otherwise connected to the electronic book hardware, the audio information converted to digital data by an analog to digital converter and stored in memory local to the electronic book housing. The audio information can, for example, include the user reading a portion of the book in his or her own voice and sound-effects created by the user that relate to the textural content of the electronic publication. The user can also upload the marked reading material to the information services system 20 where it can be stored in the centralized bookshelf 30 associated with the portable electronic book 10 for later retrieval. It is noted that there is no need to upload any unmarked reading material since it was already stored in the centralized bookshelf 30 at the time it was first requested by the portable electronic book 10. In one embodiment, the audio information can be played automatically when the user opens a page including a text segment and/or graphical element that the audio information is associated with. In another embodiment, the audio information can be played when the user uses a user interface device to position a cursor upon text segment and/or graphical element displayed as part of the electronic publication. In yet another embodiment, the audio information can be played when the user clicks a button when the cursor is positioned upon a text segment and/or graphical element.

The information services system 20 further includes an Internet Services Provider (ISP) 34 for providing Internet network access to each portable electronic book in the system.

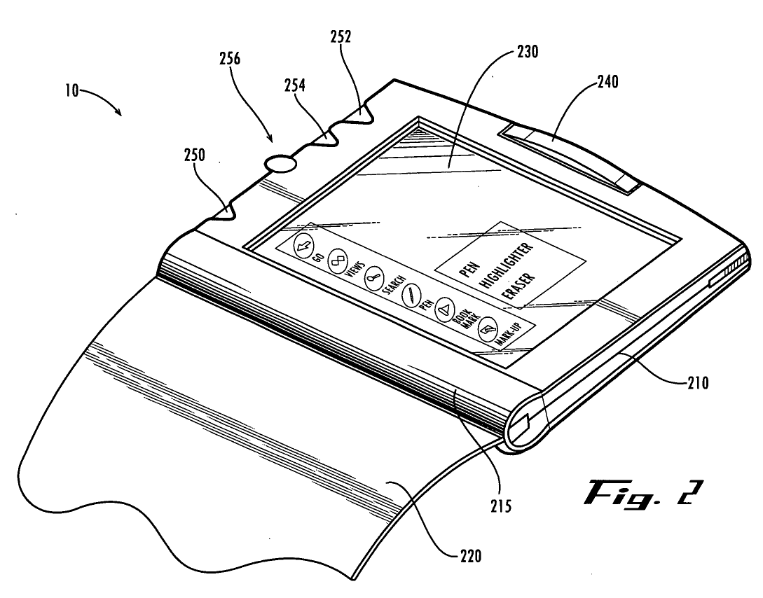

FIG. 2 illustrates an electronic book 10 in accordance with one embodiment of the present invention.

Referring to FIG. 2, an exemplary electronic book 10 includes a housing 210, a battery holder 215, a cover 220, an output port coupled to an output device such as a display screen 230, a page turning interface device 240, a menu key 250, a bookshelf key 252, a functional key 254, and an input port coupled to an input device such as a microphone 256.

The housing 210 provides overall housing structure for the electronic book. This includes the housing for the electronic subsystems, circuits, and components of the overall system. In one embodiment, the electronic book 10 can be suited for portable use and the power supply can be mainly from batteries. The battery holder 215 is attached to the housing 210 at the spine of the electronic book 10. Other power sources such as AC power can also be derived from interface circuits located in the battery holder 215. The cover 220 is used to protect the viewing area 230.

The display screen 230 provides a viewing area for the user to view the electronic reading materials retrieved from the storage devices or downloaded from the communication network. The display screen 230 may be sufficiently lit so that the user can read without the aid of other light sources. When the electronic book is in use, the user interacts with the electronic book via a soft menu 232. The soft menu 232 displays icons allowing the user to select functions. Examples of these functional icons include go, views, search, pens, bookmarks, markups, and close. In one embodiment, the soft menu 232 also includes selections related to the speech recognition features and text accentuating features disclosed herein to support users who, for example, are learning to read. The soft menu 232 may further include menu selections to enable voice calibration routines and allow users to calibrate their voices upon the given electronic book hardware. Menu selections are also included to select and/or modify how text is accentuated in response to the recognized voice of the user. Each of these icons may also include additional items. These additional items are displayed in a drop-down tray when the corresponding functional icon or key is activated by the user. An example of a drop-down tray is the pens tray which includes additional items such as pen, highlighter, and eraser. In one embodiment, the soft menu 232 can be updated dynamically and remotely via the communication network.

The page turning mechanism 240 provides a means to turn the page either backward or forward. The page turning mechanism 240 may be implemented by a mechanical element with a rotary action. When the element is rotated in one direction, the electronic book will turn the pages in one direction. When the element is turned in the opposite direction, the electronic book will also turn in the opposite direction.

In one embodiment, the page turning mechanism 240 can be provided as a tilt switch and/or accelerometer. When the user tilts the housing 210 in a particular direction, an electronic signal is generated by the tilt switch/accelerometer. Software running on the electronic book responds to the electronic signal by turning the page of the displayed document. For example, tilting the housing 210 upward on the right side by more than a threshold angle will cause the software running on the electronic book to turn the pages forward. Tilting the housing 210 downward on the right side by more than a threshold angle will cause the software running on the electronic book to turn the pages backward. Tilting the housing 210 up and down can also be sensed using a tilt switch and/or accelerometer and can have software functions associated with up and/or down tilts. For example, up and down tilts can be detected and then cause the software running on the electronic book to scroll a displayed page upward and downward respectively (or vice versa). In one embodiment, the threshold angle must be detected for more than a threshold amount of time for the software to trigger the page turning and/or page scrolling features, the direction of the turning and/or scrolling dependent upon the detected direction that the electronic book was tilted for more than the threshold amount of time. In an alternative embodiment, the page turning and/or page scrolling features of the software can be triggered when a threshold acceleration is exceeded rather than a threshold angle. In this case, the threshold acceleration is embodied as a minimum acceleration value and/or a characteristic acceleration profile that must be imparted upon the housing 210 to cause the software to turn a page and/or scroll a document. In one embodiment, the aforementioned tilt-based and/or acceleration-based page turning/scrolling features are triggered when the user presses a button and/or touch an active region on the electronic book housing 210. In this way the page will not be turned and/or the document will not be scrolled accidentally by the user as a result of accidental or unintended motion of the electronic book housing.

The menu key 250 is used to activate the soft menu 232 and to select the functional icons. The bookshelf key 255 is used to display the contents stored in the bookshelf and to activate other bookshelf functions. The functional key 254 is used for other functions.

The microphone 256 may be mounted directly upon the casing hardware of the device or may be one or more remote microphones connected to electronic book 10 by a wireless or wired data connection. Microphone 256 is situated to capture the voice of a user or users who speaks within close proximity of the electronic book. The microphone 256 is connected to analog to digital converter electronics that turns the analog signal from the microphone into digitized data representing the spoken voice of the user. The digitized data is stored in memory local to the electronic book 10 such that it can be processed by software routines running on one or more processors within the electronic book 10.

The electronic book 10 includes a view switching feature which allows readers or users to increase or decrease the size of the font used to create page display images to suit the preferences of the readers or users. As stated above, a page display image is an arrangement of pixels on a display screen or an output device to create a visual representation of a page of reading material. Each set of page display images of an electronic publication, document, or reading material that is generated using a set of view parameters is referred to as a page display view. In one embodiment, view parameters can include the point size of the font that should be used to create page display images. In another embodiment, view parameters can also include the dimensions of a display screen or a portion of a display screen of the electronic book where page display images are presented.

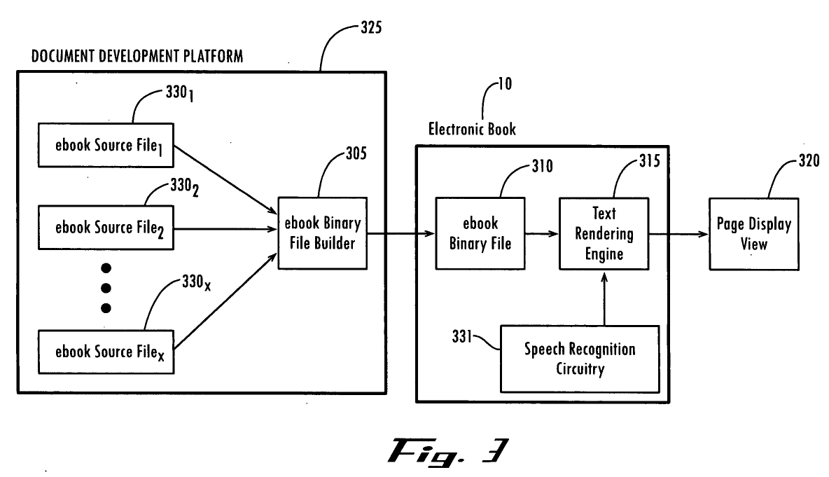

FIG. 3 illustrates a block diagram of components or modules that are used to generate page display views (including text, illustrations, and any other graphic displays) as well as the voice-coordinated accentuating of displayed text based upon the processed voice of a user in accordance with various embodiments of the present invention.

Referring to FIG. 3, electronic book (eBook) binary file builder 305 accepts as input one or more eBook source files 330₁, 330₂, 330ₓ (where x is a positive integer) describing or defining an electronic publication, document, or reading material. These source files may be downloaded from a remote server or transferred from any memory storage medium such as a compact disk or memory card. In one embodiment, eBook source files 330₁, 330₂, and 330ₓ are constructed using a format that is consistent with the “Open eBook™ Publication Structure” specification published by the Open eBook™ Authoring Group. However, eBook source files 330₁, 330₂, and 330ₓ can be constructed using other well-known document publishing formats, e.g., rich text format (rtf). Some embodiments use document publishing formats that allow both text and images.

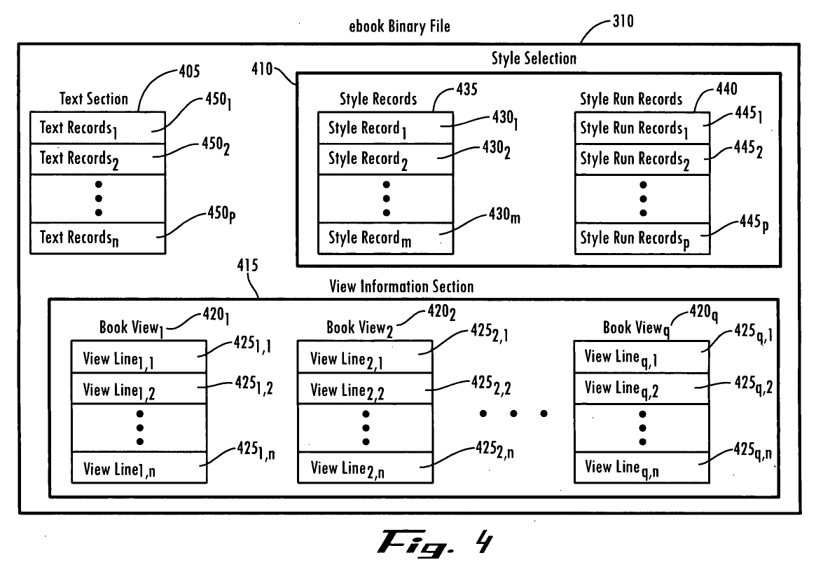

The eBook binary file builder 305: (i) parses eBook source files 330₁, 330₂, and 330ₓ describing or defining an electronic publication, document, or reading material; (ii) extracts text flow information in the eBook source files; (iii) organizes the extracted text flow information into text section 405, style section 410, and view information section 415; and (iv) stores the extracted and organized text flow information sections 405,410,415 in an eBook binary file 310, as shown in FIG. 4. In one embodiment, text flow information may include textual content, text style information, margin and indent definitions, text color information, and any other information needed to build page display images for an electronic publication, document, or reading material. Text flow information may also include data pertaining to graphics or images to be presented in a page. The graphics or images data may include the identification of the graphics or images and positioning information specifying where the graphics or images should be placed on a page. The layout of the eBook binary file 310 and the text flow information sections 405, 410,415 stored in the file 310 will be described below in more detail.

After its creation, the eBook binary file 310 can be transferred to the electronic book 10 via the system 100 described above with respect to FIG. 1. Once transferred to the electronic book 10, the eBook binary file 310 can be fed as input into the text rendering engine 315. The text rendering engine 315 parses the eBook binary file 310 and generates page display views 320 that are output. As defined above, a page display view is a set of page display images of an electronic publication, document, or reading material that is generated using a set of view parameters, which can include the point size of a base font or dimensions of a display screen or a portion of a display screen of the electronic book where page display images are presented.

The tasks of parsing eBook source files 330₁, 330₂, and 330ₓ and extracting and organizing text flow information are required in the process of generating page display images from eBook source files 330₁, 330₂, and 330ₓ. In one embodiment, text flow information is used along with the output of speech recognition circuitry 331 to accentuate words spoken by a user (e.g., a parent) during a vocal reading of the document (e.g., to a child). The document (e.g., a children's book) is stored as an eBook source file that is parsed such that text flow information is extracted and organized. The text flow information includes textual content along with relevant spatial and style information indicating where and how the textual content is displayed. For example, textual content may include the words “Once upon a time”, wherein the words are represented as the text words themselves, and the text words are associated with font, style, color, and spatial layout information. Based upon this textual content, the words “Once upon a time” are rendered upon the page in a particular location and particular style (i.e., display characteristics). Once the user begins reading and utters the word “Once” aloud, the speech recognition circuitry 331 recognizes that the textual word “once” has been recited and passes data to the rendering engine 315 indicating that the word “once” is the word that is currently being recited.

Because the word “once” could appear multiple times within the document, context information is also passed from the speed recognition circuitry 331 to the rendering engine 315 or is generated within the rendering engine 315. In one embodiment, context information determines from context (e.g., previous words spoken) which instantiation of the word “once” is the current one being spoken and thus keeps track of where the user is in the story. Based on the data passed from the speech recognition circuitry 331 and the context information, the particular occurrence of the word “once” is identified as the one that corresponds with the user's current utterance of the word “once”.

The rendering engine 315 then accentuates the graphical display of the currently uttered word “once” upon the displayed screen (i.e., renders the currently uttered word “once” with a primary accentuated set of display characteristics). Rendering the word “once,” with a primary accentuated set of display characteristics can be accomplished, for example, by highlighting the word in a particular color, underlining the word, changing the word to a bold font, changing the word to a larger font, changing the word to an italic font, changing the font color of the word, or the like, or combinations thereof.

In one embodiment, a word can rendered with the primary accentuated set of display characteristics for a fixed amount of time (e.g., 5 seconds) after it has been uttered, after which time the rendering engine 315 re-renders the uttered word with its normal set of display characteristics. In another embodiment, the uttered word can be rendered with the primary accentuated set of display characteristics for a variable amount of time until the utterance of a next word is detected by the speech recognition circuitry at which time the rendering engine 315 re-renders the current word with its normal set of display characteristics and renders the next word with the primary accentuated set of display characteristics. Accordingly, the embodiments described above allow a visual distinction to be made between a word that is currently being uttered and word(s) that have yet to be spoken.

In one embodiment, the rendering engine 315 does not re-render previously uttered words with their normal sets of display characteristics but does render them with secondary accentuated set of display characteristics, different from the primary accentuated set of display characteristics. Rendering previously uttered words with secondary accentuated set of display characteristics can be accomplished, for example, by simply rendering the previously uttered word in a bold font. Accordingly, the embodiment described above allows a visual distinction to be made between a word that is currently being uttered, word(s) that have yet to be spoken, and word(s) that have been previously spoken.

Although the discussion above relates to primary and secondary accentuated set of display characteristics and normal set of display characteristics of words, either currently spoken, previously spoken, or yet to be spoken, it will be appreciated that the aforementioned embodiments may be additionally or alternatively be extended to primary/secondary accentuated and normal set of display characteristics of syllables, either currently spoken, previously spoken, or yet to be spoken. Accordingly, the embodiments described above allow a visual distinction to be made between a syllable that is currently being spoken, syllable(s) that have yet to be spoken, and syllable(s) that have been previously spoken. For discussion purposes, words and syllables can be collectively referred to as text segments.

It should be noted that the eBook binary file builder 305, the text rendering engine 315, and the speech recognition circuitry 331 can be implemented as software modules embodied on a computer readable medium. Examples of such computer readable medium include volatile or non-volatile memory, magnetic tapes, compact disk read only memory (CDROM), floppy diskette, hard disk, optical disk, etc.

FIG. 4 illustrates one embodiment of an eBook binary file 310 in accordance with the current invention.

The eBook binary file 310 includes a text section 405, which generally stores the textual content of a document, book, or reading material. The textual content generally comprises numerous text segments. Each of the text segments comprises one or more alphanumeric characters, and is stored contiguously in a text record 450₁, 450₂, 450ₚ (where p is a positive integer) in the text section 405. In various embodiments, text segments may be provided as syllables and/or words.

The eBook binary file 310 also includes a first style section 410, which generally stores: (1) sets of text style information for the text records in the text section; and (2) data records mapping those sets of text style information to corresponding text records. Each set of text style information is stored in one style record 430₁, 430₂, 430ₘ (where m is a positive integer) in the style section 410. In order to be efficient with storage space, the first style section 410 stores only sets of information defining unique text styles which have not already been defined and stored in the first style section 410. It should be noted that each style record 430₁, 430₂, 430ₘ in the first style section 410 corresponds to one or more text records in the text section 405. The style records 430₁, 430₂, 430ₘ dictate how the text rendering engine 315 (shown in FIG. 3) should render or image the text segment(s) stored in the text record(s) corresponding to the style record. In some embodiments of the present invention, an additional style section (i.e., a second style section) is included for a given string of text, the second style section defining the style (i.e., an accentuated style) to be used for accentuating that string of text when that particular text string is recited aloud by a user as identified by speech recognition circuitry in accordance with the present invention.

As described above, the style records contain information that the text rendering engine 315 (shown in FIG. 3) uses to render or image text record or text records corresponding to the style records. It should be noted that each text record can correspond to one or more style records.

As described above, when accentuating text in coordination with (i.e., substantially simultaneously with) the recognized vocalizations of a user reading the text aloud, the accentuating can be performed in a variety of ways including changing the font type (e.g., Times New Roman, Arial, etc.), font size (e.g., 12 pt, 16 pt, 20 pt, etc.), font style (e.g., bold, italics, underlined, etc.), font color (e.g., black, blue, red, etc.), background color (e.g., yellow, red, blue, etc.), font effects (e.g., strikethrough, outline, emboss, engrave, all caps, etc.), and text effects (e.g., blinking background, text shimmer, etc.), and the like, or combinations thereof, of the text that has been and/or is currently being vocalized by the user. In some embodiments, the visual characteristics used to accentuate the currently spoken text are user definable through a menu of choices present within the user interface of the eBook. In this way a user can select the method accentuating text in a manner that he or she finds most pleasing. The user can also store selected method of accentuating text in memory local to the eBook device. In some embodiments, the accentuating preferences of that user can be automatically accessed from memory and implemented accordingly when the user logs into the eBook for a reading session.

In some embodiments, the style used for accentuating text that has been and/or is currently being vocalized by the user can be hard-coded into the permanent memory of the eBook and is not dependent upon either the binary file of the particular electronic document being accessed or the configuration data entered by the user. In such embodiments, the method of accentuating the text that has been and/or is currently being vocalized by the user is generally the same (e.g., the text is always made bold and/or the text is always made bold and highlighted).

In some embodiments, each page display image includes an ordered series of text segments (e.g., syllables and/or words) that are expected to be read in progression. Accordingly, the speech recognition circuitry 331 can be configured to wait for the first text segment in the ordered series of text segments on a given page to be uttered (or partially uttered) before accentuating that text segment. The speech recognition circuitry 331 can further be configured to wait for the subsequent text segment in the ordered series of text segments to be uttered (or partially uttered) before accentuating that subsequent text segment. In this way, the user can read the text starting from the beginning of the page display image, digress from the text at will—during which time none of the text segments are accentuated, and return to the text and resume accentuating of text segments in close time-proximity to each utterance of the user.

In one embodiment, the speech recognition circuitry 331 can be configured to accentuate any text segment within a current page display image upon being read by the user after some predetermined event has transpired (e.g., after the user has been silent for a predetermined amount of time, after the user has pressed a user-interface button, uttered a voice command, etc.). Once a text segment is eventually accentuated, the system follows the expected order of text segments as described in the paragraph above. In this way, the reader can re-read portions of the page display image and have the text segments included therein re-accentuated before moving on to subsequent text segments and/or page display images.

In some cases, portions within an ordered series of text segments may occur multiple times. Accordingly, after the predetermined event has transpired, it may be uncertain as to exactly which text segment the user has uttered. For example, after the predetermined event has transpired, the user may wish to re-read the word “and” or “the.” In this case, the speech recognition circuitry can be configured to wait for the user to utter one or more next text segments in the ordered series of text segments until the uncertainty is resolved. Once the uncertainty is resolved, the currently uttered text segment can be accentuated as described above.

FIGS. 5, 6, and 7 generally illustrate exemplary displays of an electronic book in one embodiment of the present invention.

Referring to FIG. 5, the electronic display shows a graphical rendering, including text and illustrations, of a page of a popular children's book—The Cat in the Hat. The page of the book shown is page seven of the full set of sixty-one pages of the book. In a common embodiment of the present invention the electronic book stores all 61 pages of this children's book in local memory and displays each page in consecutive order to the user, wherein the displayed pages are advanced in response to a user interface input command from the user that indicated an advancing of pages is desired. To arrive at the illustrated page seven, the user, for example, may have previously been looking at page six and pressed a “page advance” button to flip forward to page seven, as currently displayed. Once the user finishes with page seven, the user can press the “page advance” button again to display page 8 of the book. It will be appreciated that a similar user interface method can be used to allow the user to turn pages backward if desired. In other embodiments, user interface methods can be used to allow the user to jump (either forward or backward) to a particular page, jump to a particular section, jump to a particular chapter, and/or to some other identifiable place (e.g., a particular word, line, paragraph, etc.) within the electronic document. In some embodiments, the user interface command to turn a page is a user's verbal utterance of a particular word or phrase (e.g., “next page”) that is detected by the speech recognition circuitry 331 described herein. When the speech recognition circuitry 331 identifies that this phrase has been uttered, the page advances. Other methods of commanding that the electronic book advance a page includes user manipulation of buttons, dials, knobs, levers, and/or other manual input apparatus.

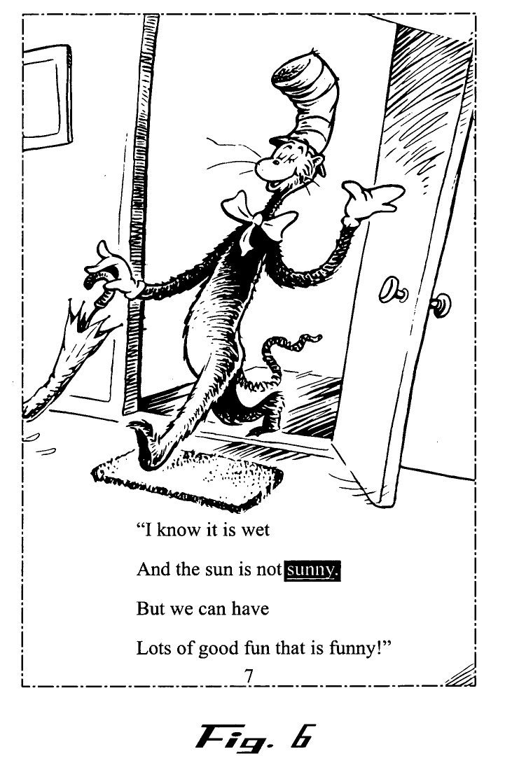

Consistent with the methods and apparatus of the current invention, a story (e.g., The Cat in the Hat) stored within the electronic can be read to a child (or other unskilled reader) by a reading user (e.g., an adult or other skilled reader), wherein the electronic display of the eBook is viewable by both the adult and child. As the reading user is reading the story aloud, his or her voice is captured by a microphone on the eBook as an input analog signal. The input analog signal is converted to a digital signal and processed using speech recognition circuitry 331. As described previously, the speech recognition circuitry 331 processes the user's captured voice by identifying phonemes and determining the word that the user is most likely saying. In the present example, the reading user is saying the word “sunny.” Upon determining that the reading user is most likely saying the word “sunny,” the speech recognition circuitry 331 passes data to the rendering engine 315 indicating that the word “sunny” is the word that is currently being recited. The rendering engine 315 then renders the word “sunny” with an accentuated set of display characteristics on the displayed screen as shown in FIG. 6. As exemplarily shown in FIG. 6, the word “sunny” appears in bold text, with underline, and with a background highlight (e.g., yellow) around it.

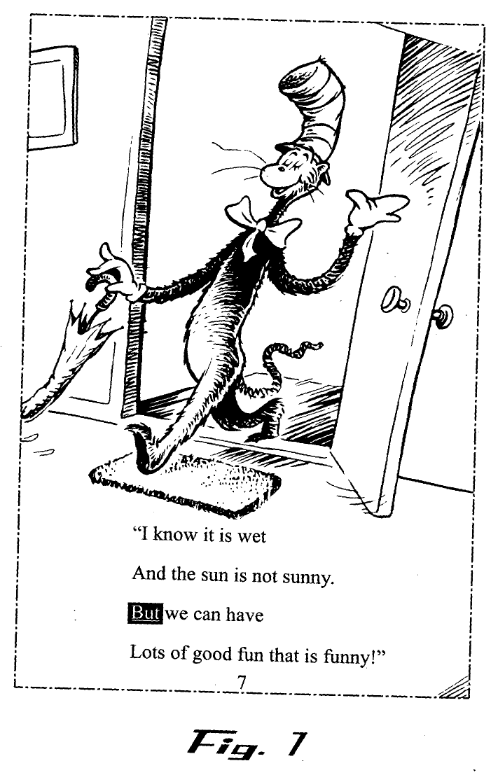

In one embodiment, the word “sunny” is rendered with the accentuated set of display characteristics substantially simultaneously after the reading user finishes reciting the word “sunny.” As used herein, the term “substantially simultaneously” implies that the rendering is completed after the user finishes reciting the word but within human limits of perception. In another embodiment, the word “sunny” is rendered with the accentuated set of display characteristics before the reading user finishes reciting the word when the speech recognition circuitry 331 determine that the reading user is going to say the word “sunny” based upon a portion of the utterance. Accordingly, the child can see the visual accentuation of a word in very close time-proximity to the adult reader's vocalization of the word and can, therefore, see which word corresponds to the reader's vocalization. When the adult user recites the next word, the process of speech recognition of text rendering is repeated and the next word “But” is accentuated as shown in FIG. 7. This process continues word by word as the adult reader reads the story thereby allowing the child user to follow the reading of the story, word by word, the visual text correlated to the spoken word by the clear graphically accentuated display. In this way the current invention provides a powerful computer-supported educational tool for teaching reading to a child user while keeping the adult user directly involved in the child-adult bonding process. In this way the current invention does not replace the adult in the teaching process but supports the adult with computer enhanced educational content.

In one embodiment, the pages can be automatically advanced using, for example, the speech recognition circuitry 331 disclosed herein. For example, the software can monitor the process of the reader as he or she recites the words from the current story and determine when the last word on a given page has been recited by the user. In one embodiment, the software can be configured to automatically advance to the next page once that last word on a currently displayed page has been recited either immediately or after a predetermined amount of time (e.g., after six seconds). In this way, a child may be given time to look at the final recited word (accentuated as described above) and make a mental connection with the word that was just spoken by the adult user before the page is automatically turned. In some embodiments, the aforementioned automatic page turning feature can be turned on or off via a user interface upon the electronic book.

In one embodiment, the electronic book hardware described above can further include a video projector adapted to display a large image to a group of users (e.g., a teacher and number of child students). In this case, the teacher is the reading user and recites the words displayed on the screen while the child students sit and watch as the corresponding text words are accentuated upon the projected display. In this way a teacher can have a computer-enhanced story time with a group of kids. In some embodiments multiple displays (e.g., a small display for the teacher and large projected display for the students) may be used in conjunction with the electronic book described above. In this way, the teacher can sit comfortably facing the students and the students can view the large display. Such a configuration can be achieved by having a video output port upon the portable electronic book hardware as shown in FIG. 2, wherein the video output port connects to a video projector adapted to display a duplicate image upon a large screen or other large surface.

In one embodiment, the electronic book can also be used in a group mode in which students can take read the displayed words aloud (e.g., together as a group or by taking turns). As the words are read by the student(s) they are accentuated for the rest of the student body to view. If a student mispronounces a word or otherwise makes a mistake, the software can be configured to indicate that mistake was made and can wait for a correct pronunciation.

While the invention herein disclosed has been described by means of specific embodiments, examples and applications thereof, numerous modifications and variations could be made thereto by those skilled in the art without departing from the scope of the invention set forth in the claims.

What is claimed is:

1. A method of visually correlating text and speech, comprising:
receiving a source file;
generating, based on the source file, a page display image including a series of text segments, the generating including rendering the series of text segments with a first set of display characteristics;
receiving an input signal representing an utterance;
processing the received input signal to determine whether at least a portion of a text segment included within the generated page display image has been uttered;
identifying the text segment determined to have been at least partially uttered;
rendering the identified text segment with a second set of display characteristics; and
enabling the generated page display image to be visually represented on an output device;
wherein the identified text segment is rendered with the second set of display characteristics substantially simultaneously upon receiving the input signal.

2. The method of claim 1, wherein the text segment includes a syllable.

3. The method of claim 2, wherein the text segment includes a word.

4. The method of claim 1, wherein at least one of the first and second set of display characteristics includes at least one of a font type, font size, font style, font color, background color, font effects, and text effects.

5. The method of claim 1, wherein rendering the identified text segment with the second set of display characteristics includes accentuating the identified text segment with respect to text segments rendered with the first set of display characteristics.

6. The method of claim 1, further comprising re-rendering the identified text segment with the first set of display characteristics after a predetermined amount of time.

7. The method of claim 1, further comprising:
processing the received input signal to determine whether at least a portion of a text segment immediately succeeding the previously identified text segment in the series of text segments has been spoken;
identifying the succeeding text segment determined to have been at least partially spoken; and
rendering the identified succeeding text segment with the second set of display characteristics.

8. The method of claim 7, further comprising rendering the previously identified text segment with the first set of display characteristics.

9. The method of claim 7, further comprising rendering the previously identified text segment with a third set of display characteristics.

10. The method of claim 1, wherein receiving the input signal includes receiving an input signal representing an utterance of a single user.

11. The method of claim 1, wherein receiving the input signal includes receiving an input signal representing an utterance of a plurality of users.

12. The method of claim 1, further comprising:
generating a plurality of page display images based on the received source file, wherein each page display images contains a series of text segments; and
selecting from one of the plurality of page display images to be visually represented on the output device.

13. The method of claim 12, wherein the selecting includes:
processing the received input signal to determine whether a last text segment in the series of text segments within the visually represented page display image has been uttered; and
visually representing a different page display image upon determining that the last text segment has been uttered.

14. The method of claim 13, further comprising visually representing the different page display image after a predetermined amount of time upon determining that the last text segment has been uttered.

15. The method of claim 12, wherein the selecting includes receiving an instruction from a user to visual represent a different page display image.

16. The method of claim 15, wherein the instruction includes at least one of a verbal instruction and a manual instruction.

17. The method of claim 1, further comprising visually representing the generated page display image on a monitor.

18. The method of claim 1, further comprising visually representing the generated page display image on a viewing surface by a projector.

19. A system for visually correlating text and speech, comprising:
a storage medium adapted to store a source file;
a text rendering engine adapted to generate a page display image based on the source file, the page display image including a series of text segments rendered with a first set of display characteristics;
an input port adapted to receive an input signal representing an utterance;
speech recognition circuitry adapted to process the received input signal, determine whether at least a portion of a text segment included within the generated page display image has been uttered, and to output data to the text rendering engine, the output data identifying the text segment determined to have been at least partially uttered; and
an output port adapted to transmit the generated page display image to an output device, wherein the text rendering engine is further adapted to render text segments identified by the speech recognition circuitry with a second set of display characteristics substantially simultaneously upon receiving the input signal.

20. The system of claim 19, wherein the text segment includes a syllable.

21. The system of claim 20, wherein the text segment includes a word.

22. The system of claim 19, wherein at least one of the first and second set of display characteristics includes at least one of a font type, font size, font style, font color, background color, font effects, and text effects.

23. The system of claim 19, wherein speech recognition circuitry is adapted to accentuate the identified text segment with respect to text segments rendered with the first set of display characteristics.

24. The system of claim 19, wherein the text rendering engine is further adapted to re-render the identified text segment with the first set of display characteristics after a predetermined amount of time.

25. The system of claim 19, wherein the speech recognition circuitry is further adapted to:
process the received input signal to determine whether at least a portion of a text segment immediately succeeding the previously identified text segment in the series of text segments has been spoken;
identify the succeeding text segment determined to have been at least partially spoken; and
render the identified succeeding text segment with the second set of display characteristics.

26. The system of claim 25, wherein the text rendering engine is further adapted to render the previously identified text segment with the first set of display characteristics.

27. The system of claim 25, wherein the text rendering engine is further adapted to the previously identified text segment with a third set of display characteristics.

28. The system of claim 19, further comprising a microphone coupled to the input port.

29. The system of claim 28, further comprising a plurality of microphones coupled to the input port.

30. The system of claim 19, wherein the text rendering engine is adapted to generate a plurality of page display images based on the source file, wherein each page display image contains a series of text segments, the system further comprising:
a user interface adapted to select one of the plurality of page display images to be transmitted by the output port.

31. The system of claim 30, wherein the user interface is adapted to enable automatic selection of one of the plurality of page display images to be transmitted by the output port.

32. The system of claim 30, wherein the user interface is adapted to enable manual selection of one of the plurality of page display images to be transmitted by the output port.

33. The system of claim 32, further comprising a housing adapted to be held by a user, wherein the user interface includes a page turning mechanism coupled to the housing and adapted to select one of the plurality of page display images to be transmitted by the output port based on an orientation of the housing.

34. The system of claim 30, wherein the instruction includes at least one of verbal selection of one of the plurality of page display images to be transmitted by the output port.

35. The system of claim 19, further comprising the output device, wherein the output device includes a monitor.

36. The system of claim 19, further comprising the output device, wherein the output device includes a projector.
